(19) United States
(12) Patent Application Publication
(10) Pub. No.: US 2013/0196819 A1
(43) Pub. Date: Aug. 1, 2013

(54) METHOD OF CONTROLLING A SPEED OF AN ENGINE RELATIVE TO A TURBINE SPEED OF A TORQUE CONVERTER

(71) Applicants: Krishnendu Kar, South Lyon, MI (US); Kristian Keary, Troy, MI (US)

(72) Inventors: Krishnendu Kar, South Lyon, MI (US); Kristian Keary, Troy, MI (US)

(73) Assignee: GM GLOBAL TECHNOLOGY OPERATIONS LLC, Detroit, MI (US)

(21) Appl. No.: 13/361,162

(22) Filed: Jan. 30, 2012

(51) Int. Cl. B60W 10/06; B60W 10/02

(52) U.S. Cl. 477/54

(57) ABSTRACT

A method of controlling a vehicle includes identifying an operating state of a torque converter clutch to be one of a locked operating state, or an unlocked operating state. A rotational speed of a turbine of a torque converter is sensed. When the torque converter clutch is operating in the locked operating state, a desired engine speed is defined to equal the sensed rotational speed of the turbine less a first slip value. When the torque converter clutch is operating in the unlocked operating state, the desired engine speed is defined to equal the sensed rotational speed of the turbine less a second slip value. At least one operating parameter of the engine is adjusted to control a torque output of the engine to affect a rotational speed of the engine so that the rotational speed of the engine is equal to the defined desired engine speed.

The invention generally relates to a method of controlling a vehicle, and more specifically to controlling an engine speed relative to a turbine speed of a torque converter clutch to reduce driveline lash when the torque converter clutch is disposed in an unlocked operating state.

### BACKGROUND

Vehicles may include a fluid coupling, e.g., a torque converter, that interconnects an output from an engine with an input into a transmission. The vehicle may further include a torque converter clutch that mechanically connects a turbine of the torque converter to a pump of the torque converter. When the rotational speed of the engine is relatively constant and approximately equal to the rotational speed of the turbine, the torque converter clutch may be positioned in a locked operating state to mechanically connect the output of the engine and the input of the transmission to reduce energy losses through the torque converter. At other times, such as during acceleration or braking, the torque converter clutch may be positioned in an unlocked operating state to disconnect the mechanical connection between the output of the engine and the input of the transmission and allow relative slippage between the turbine and the pump of the torque converter.

When the torque converter clutch is in the unlocked operating state, the transmission is not actively controlling the rotational speed of the engine. It is desirable to have the rotational speed of the engine less than the rotational speed of the turbine to ensure that there is enough negative acceleration when the vehicle is coasting to reduce a sail-on effect, and to prevent acceleration during fast braking, which may occur if the rotational speed of the turbine falls below the rotational speed of the engine. During coastdown, the torque output of the engine is controlled to regulate the rotational speed of the engine so that the rotational speed of the engine does not greatly differ from a rotational speed of the turbine of the torque converter. Typically, a control module will adjust certain operating parameters, such as the timing and/or throttle position, to regulate the torque output of the engine to control the rotational speed of the engine. The control module references a table that defines desired values for the certain operating parameters given the specific operating conditions of the vehicle. The control module then adjusts the various operating parameters to achieve the desired engine speed. In so doing, the rotational engine speed may be as much as 200 to 400 rpm below the rotational speed of the turbine to ensure that the rotational speed of the engine is not greater than the rotational speed of the turbine. However, this high lash, i.e., the 200 to 400 rpm difference between the rotational speed of the engine and the rotational speed of the turbine, may cause a tip-in bump and/or delay in vehicle acceleration that would be undesirable.

### SUMMARY

A method of controlling a vehicle is provided. The method includes identifying an operating state of a torque converter clutch to be one of a locked operating state in which the torque converter clutch mechanically interconnects an output of an engine with an input of a transmission, or an unlocked operating state in which the torque converter clutch is mechanically disconnected from and allows relative slippage between the output of the engine and the input of the transmission. A rotational speed of a turbine of a torque converter is sensed. When the torque converter clutch is operating in the locked operating state, a desired engine speed is defined to equal the sensed rotational speed of the turbine minus a first slip value. When the torque converter clutch is operating in the unlocked operating state, the desired engine speed is defined to equal the sensed rotational speed of the turbine minus a second slip value. At least one operating parameter of the internal combustion engine is adjusted to control a torque output of the internal combustion engine. Controlling the torque output affects a rotational speed of the internal combustion engine so that the rotational speed of the internal combustion engine is equal to the defined desired engine speed.

Accordingly, when the torque converter clutch is in the unlocked operating state, the rotational speed of the engine is controlled to be within the second slip value of the rotational speed of the turbine of the torque converter. For example, the second slip value may be defined to equal a value between 75 and 125 rpm. This allows the rotational speed of the engine to be continuously controlled to a value much closer to the rotational speed of the turbine, thereby reducing the tip-in bump and/or delay in acceleration caused by excessive lash therebetween, i.e., an excessive difference between rotational speeds therebetween.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a graph showing a rotational speed of a turbine, a desired engine speed over time, and an immediate torque request profile over time.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

Referring to the Figure, a method of controlling a vehicle is provided. The method controls the rotational speed of an engine, such as but not limited to an internal combustion engine, relative to a rotational speed of a turbine of a torque converter. By maintaining the rotational speed of the engine at a level near but slightly less than the rotational speed of the turbine, such as for example within 75 rpm, the response time and tip-in bump associated with a sudden acceleration is reduced and/or improved.

The method may be implemented and/or embodied as a control algorithm operable on a control system of the vehicle. For example, the control system may include a control module, e.g., a computer, in communication with and in control over various components of the vehicle, such as but not limited to the engine, a transmission, the torque converter, a torque converter clutch, and one or more sensors associated with one more of the various components of the control system. The control system may further include all memory, software, hardware, electrical and communications connections, etc. needed to perform the various operations of the disclosed method. Accordingly, it should be appreciated that any of the various method steps or operations described below may be performed and/or executed by the control system.

The method includes identifying an operating position of the transmission. The transmission may be disposed in one of several different operating positions, including but not limited to a park position, a neutral position, a forward drive position or a reverse drive position. It should be appreciated that the forward drive position may include several different gear ratios, each providing a forward drive position. The control system may identify or determine the specific operating position in which the transmission is currently operating in any suitable manner, including but not limited to sensing the position of various components of the transmission to determine the current operating position of the transmission, or querying a transmission control module on the current operating position of the transmission.

The method further includes identifying an operating state of the torque converter clutch. The torque converter clutch may be disposed in either a locked operating state or an unlocked operating state. When in the locked operating state, the torque converter clutch mechanically interconnects a pump of the torque converter, which is directly connected to an output of the engine for direct rotation therewith, with the turbine of the torque converter so that the turbine of the torque converter directly rotates or rotates at a controlled level of slip with the pump. When in the unlocked operating state, the torque converter clutch is mechanically disconnected from and allows relative slippage between the pump and the turbine, thereby allowing relative slippage between the output of the engine and the input of the transmission. The control system may identify or determine the specific operating state of the torque converter clutch in any suitable manner, including but not limited to sensing the position of the torque converter clutch to determine the current operating state thereof, or by querying a control module on the current operating state of the torque converter clutch.

A rotational speed of the turbine of the torque converter is sensed. The rotational speed of the turbine may be sensed in any suitable manner, including but not limited to sensing the rotational speed with a rotary speed sensor or other similar device capable of sensing the rotational speed of the turbine and communicating the rotational speed of the turbine to the control system. The rotational speed of the turbine may be continuously sensed over time, or may be sensed at preset time intervals. The sensed turbine speed may be filtered by the control system over time to define a filtered running average of the turbine speed. The control system may filter the sensed rotational speed of the turbine with any suitable filter to remove any local peaks and/or spikes in the instantaneous measurement of the rotational speed of the turbine.

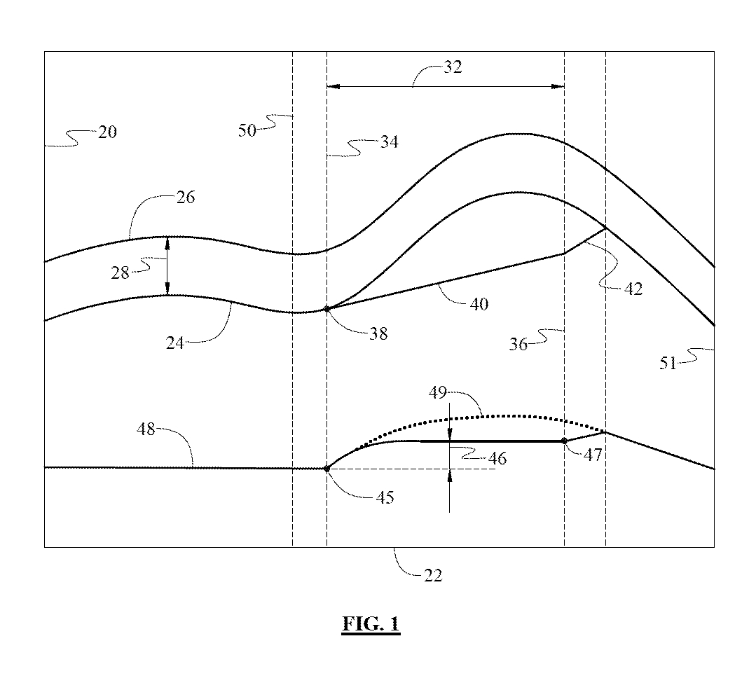

Once the rotational speed of the turbine has been sensed and filtered, a desired engine speed is defined. Referring to FIG. 1, rotational speed in revolutions per minute (rpm) are shown in a vertical axis 20, and time is indicated on a horizontal axis 22. When the transmission is operating in the forward drive position and when the torque converter clutch is operating in the locked operating state, the desired engine speed, generally shown at 24 in FIG. 1, may be defined to equal the sensed rotational speed of the turbine, generally shown at 26 in FIG. 1, less (minus) a first slip value. For example, the first slip value may be set equal to a value between the range of 200 and 400 rpm in order to avoid entering an engine speed control mode unless needed. When the transmission is operating in one of the forward drive positions and when the torque converter clutch is operating in the unlocked operating state, the desired engine speed may be defined to equal the sensed rotational speed of the turbine less (minus) a second slip value. For example, the second slip value may be set to equal a value between the range of 0 and 200 rpm. The first slip value and the second slip value are generally shown by the dimension line 28.

Once the desired engine speed is defined as an offset from the turbine speed and the actual engine speed is within a defined range of the desired engine speed, then at least one operating parameter of the engine is adjusted to control a torque output of the engine. Controlling the torque output of the engine affects the rotational speed of the internal combustion engine. Accordingly, by controlling the torque output of the engine, the rotational speed of the engine may be controlled to equal or closely approximate the defined desired engine speed. The operating parameters that are adjusted to control the torque output of the engine may include but are not limited to a timing of the engine, a throttle position of the engine, or a gas/air mixture ratio of the engine.

The engine speed control is applied only when the rotational speed of the internal combustion engine is within a pre-determined range of a DFCO exit engine speed. The DFCO exit engine speed is the rotational speed of the engine at which the vehicle or the engine is taken out of the DFCO mode, and the engine is once again fueled. For example, the DFCO exit engine speed may be defined as but not limited to an engine speed of nine hundred (900) to one thousand (1,000) rpm. Upon the engine reaching the DFCO exit speed or falling within the pre-determined range thereof, the method as described above may be implemented. The pre-determined range of the method may be defined as but not limited to a range of between zero (0) to one thousand (1,000) rpm, and is a function of how quickly the engine speed is changing and the sensed vehicle speed.

The method further includes detecting a change in the operating state of the torque converter clutch from one of the locked operating state or the unlocked operating state to the other of the locked operating state or the unlocked operating state. Because a different slip value is used to calculate the desired engine speed relative to the turbine speed in the locked operating state and the unlocked operating state, the defined desired engine speed when the torque converter clutch is in the locked operating state is different than the defined desired engine speed when the torque converter clutch is in the unlocked operating state. Accordingly, when the operating state transitions between the locked operating state and the unlocked operating state, the defined desired engine speed must also transition respectively. Therefore, the method includes blending the value of the defined engine speed for when the torque converter clutch is operating in the locked operating state with the value of the defined engine speed for when the torque converter clutch is operating in the unlocked operating state to transition therebetween when a change in the operating state of the torque converter clutch is detected. The defined desired engine speed is blended over a period of time. For example, the control system may blend the values of the defined desired engine speed for the different operating states of the torque converter clutch over the time constant of the engine. The time constant of the engine is a function of engine speed, volumetric efficiency and manifold to engine displacement.

As noted above, the rotational speed of the engine is affected by controlling the torque output of the engine. However, in order to ensure that the engine does not stall, a minimum torque output limit is defined. The minimum torque output limit defines a minimum floor to which the control system does not adjust the torque output of the engine below. The minimum torque output limit is set to a value equal to the greater of 1) a minimum predicted torque output without a transmission load or a torque reserve factored in, or 2) an absolute minimum torque threshold of a combustion limit of the internal combustion engine. The minimum predicted torque output is calculated by the control system, and does not include any portion thereof derived from the transmission load or the torque reserve. As used herein, the transmission load may be considered the amount of torque that is applied to the engine by the transmission; and the torque reserve may be considered the maximum range of torque authority that can be accomplished by changing the engine timing. The minimum predicted torque output is calculated without the transmission load or the torque reserve because the predicted limit would be artificially high with these components. The limit would be reached under normal conditions and the engine speed would not be able to go down to the desired engine speed. The absolute minimum torque threshold pertains to the combustion limit of the internal combustion engine and may be defined as the minimum commanded torque below which unstable combustion (misfire) will occur. The greatest or highest of these two values is defined as the minimum torque output limit to ensure that the engine does not stall during the engine speed control. When adjusting the one or more operating parameters of the engine to control a torque output of the engine, the torque output is maintained equal to or above the minimum torque output limit.

The method may further include identifying the beginning of a shift between different gear ratios of the transmission. As shown in FIG. 1, a shift between gear ratios is generally shown at 32, with the shift beginning at a time generally indicated by reference line 34, and ending at a time generally indicated by reference line 36. The commanded shift point is indicated as line 50. However, the commanded shift point is not accurate enough for this method to work. The beginning of the shift used in this method is therefore determined by the beginning of the actual gear ratio change as calculated by the transmission control module. As noted above, the forward drive position of the transmission may include several different gear ratios. It is desirable that during a closed throttle downshift, while the vehicle is operating under the engine speed control strategy described herein, that the engine torque request remains relatively constant. Accordingly, it is important to accommodate the shifting between gear ratios within the scope of the disclosed method.

In order to apply the method of engine speed control described herein, both the desired engine speed and the immediate torque request must be controlled during the shift between gear ratios. The immediate torque request is the request from the control system at any given moment in time to achieve a specific torque output of the engine to obtain the desired engine speed. Accordingly, the immediate torque request is continuously changing over time.

FIG. 1 also shows the final speed control immediate torque request, indicated by line 48. The right axis, indicated at 51, represents the engine torque. The value of this torque request is saved when the beginning of the shift is detected, indicated by reference point 45 in FIG. 1. In other words, as soon as a shift between gear ratios is detected, the control system senses the current value of the immediate torque request, and saves the current value of the immediate torque request for further reference as the initial immediate torque request.

A final speed control immediate torque request is defined to equal the lesser (smallest) of: 1) the current immediate torque request, or 2) the initial immediate torque request plus a maximum delta torque. The current immediate torque is the value of the torque needed to maintain the desired engine speed. Ideally, the final speed control immediate torque will remain constant during the gear ratio shift period. However, some increase in torque is often necessary and this increase is limited to the maximum delta torque, shown as 46 in FIG. 1. The maximum delta torque is the maximum amount of torque that can be added during a shift, and is a function of the vehicle deceleration rate and an engine speed error. Accordingly, the maximum delta torque is variable and changes given the specific operating conditions of the vehicle. As shown in FIG. 1, the dotted line 49 represents what the final speed control immediate torque request would have been without the limitation of the maximum delta torque.

During a closed throttle downshift, the desired engine speed is incremented at a pre-determined rate, indicated by the slope of the line 40, from the current defined desired engine speed that was sensed and saved at the time of the beginning of the shift. The desired engine speed is incremented at the pre-determined rate until the shift is completed. The control system only modifies the current immediate torque request if the actual rotational engine speed falls below the incremented desired engine speed. If the actual engine speed falls below the incremented desired engine speed, then the control system will increase the immediate torque request to bring the actual engine speed up to a level equal to or just above the incremented engine speed request. The immediate torque request will not be decreased to bring the actual engine speed down to the desired engine speed during the shift.

Upon the completion of the shift between gear ratios, the value of the desired engine speed may differ from the defined desired engine speed, i.e., the negative offset from the turbine speed by either the first slip value or the second slip value, because the desired engine speed was incremented at the predefined rate. Accordingly, the desired engine speed at the completion of the shift is blended over time with the defined desired engine speed to transition back into the defined desired engine speed, as generally indicated by line 42. Similarly, the final speed control immediate torque request at the completion of the shift is blended with the current speed control torque request at a completion of the shift, generally indicated by line 47. The desired engine speed and the speed control torque request may be blended over the time constant of the engine. The time constant of the engine is a function of engine speed, volumetric efficiency and manifold to engine displacement.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method of controlling a vehicle, the method comprising:
defining a desired engine speed to equal a sensed rotational speed of a turbine of a torque converter minus a first slip value when a torque converter clutch is operating in a locked operating state;
defining the desired engine speed to equal the sensed rotational speed of the turbine minus a second slip value when the torque converter clutch is operating in an unlocked operating state; and
adjusting at least one operating parameter of the internal combustion engine to control a torque output of the internal combustion engine to affect a rotational speed of the internal combustion engine so that the rotational speed of the internal combustion engine is equal to the defined desired engine speed.

2. A method as set forth in claim 1 further comprising blending the value of the defined engine speed for when the torque converter clutch is operating in the locked operating state with the value of the defined engine speed for when the torque converter clutch is operating in the unlocked operating state to transition therebetween when a change in the operating state of the torque converter clutch is detected.

3. A method as set forth in claim 1 wherein adjusting at least one operating parameter of the internal combustion engine to control a torque output of the internal combustion engine to affect a rotational speed of the internal combustion engine so that the rotational speed of the internal combustion engine is equal to the defined desired engine speed occurs only when the rotational speed of the internal combustion engine is within a pre-determined range of a Deceleration Fuel Cut-Off (DFCO) exit engine speed.

4. A method as set forth in claim 1 further comprising defining a minimum torque output limit to equal the greater of a minimum predicted torque output without a transmission load or a torque reserve factored in, or an absolute minimum torque threshold of a combustion limit of the internal combustion engine.

5. A method as set forth in claim 4 wherein adjusting at least one operating parameter of the internal combustion engine to control a torque output of the internal combustion engine includes maintaining the torque output of the internal combustion engine equal to or above the minimum torque output limit.

6. A method as set forth in claim 1 further comprising identifying the beginning of a shift between different gear ratios of the transmission.

7. A method as set forth in claim 6 further comprising incrementing the desired engine speed at a pre-determined rate from the defined desired engine speed at the time of the beginning of the shift.

8. A method as set forth in claim 6 further comprising sensing a current speed control immediate torque request at the time of the beginning of the shift.

9. A method as set forth in claim 6 further comprising defining a final speed control immediate torque request as equal to the lesser of a current calculated immediate torque, or the initial immediate torque request plus a maximum delta torque.

10. A method as set forth in claim 6 wherein the immediate torque is only modified if the actual engine speed goes below the desired engine speed.

11. A method as set forth in claim 6 further comprising blending the final speed control immediate torque request with a current speed control immediate torque request at a completion of the shift, and blending the incremented engine speed at the completion of the shift with the defined desired engine speed at the completion of the shift.

12. A method of controlling a vehicle, the method comprising:
defining a desired engine speed to equal a sensed rotational speed of a turbine of a torque converter minus a first slip value when a torque converter clutch is operating in a locked operating state;
defining the desired engine speed to equal the sensed rotational speed of the turbine minus a second slip value when the torque converter clutch is operating in an unlocked operating state;
defining a minimum torque output limit to equal the greater of a minimum predicted torque output without a transmission load or a torque reserve factored in, or an absolute minimum torque threshold of a combustion limit of the internal combustion engine;
adjusting at least one operating parameter of the internal combustion engine to control a torque output of the internal combustion engine to affect a rotational speed of the internal combustion engine so that the rotational speed of the internal combustion engine is equal to the defined desired engine speed;
identifying the beginning of a shift between different gear ratios of the transmission; and
blending the final speed control immediate torque request with a current speed control immediate torque request at a completion of the shift, and blending the incremented engine speed at the completion of the shift with the defined desired engine speed at the completion of the shift.

13. A method as set forth in claim 12 further comprising blending the value of the defined engine speed for when the torque converter clutch is operating in the locked operating state with the value of the defined engine speed for when the torque converter clutch is operating in the unlocked operating state to transition therebetween when a change in the operating state of the torque converter clutch is detected.

14. A method as set forth in claim 12 wherein adjusting at least one operating parameter of the internal combustion engine to control a torque output of the internal combustion engine to affect a rotational speed of the internal combustion engine so that the rotational speed of the internal combustion engine is equal to the defined desired engine speed occurs only when the rotational speed of the internal combustion engine is within a pre-determined range of a Deceleration Fuel Cut-Off (DFCO) exit engine speed.

15. A method as set forth in claim 12 wherein adjusting at least one operating parameter of the internal combustion engine to control a torque output of the internal combustion engine includes maintaining the torque output of the internal combustion engine equal to or above the minimum torque output limit.

16. A method as set forth in claim 12 further comprising incrementing the desired engine speed at a pre-determined rate from the defined desired engine speed at the time of the beginning of the shift.

17. A method as set forth in claim 12 further comprising sensing a current speed control immediate torque request at the time of the beginning of the shift.

18. A method as set forth in claim 12 further comprising defining a final speed control immediate torque request as equal to the lesser of a current calculated immediate torque, or the initial immediate torque request plus a maximum delta torque.

19. A method as set forth in claim 12 wherein the immediate torque is only modified if the actual engine speed goes below the desired engine speed.

20. A method as set forth in claim 12 further comprising blending the final speed control immediate torque request with a current speed control immediate torque request at a completion of the shift, and blending the incremented engine speed at the completion of the shift with the defined desired engine speed at the completion of the shift.
